(19) United States
(12) Patent Application Publication
(10) Pub. No.: US 2008/0117904 A1
(43) Pub. Date: May 22, 2008

(54) Framework for network coding and cross-layer information exchange in presence of errors in the packets

(75) Inventors: Hayder Radha, East Lansing, MI (US); Shirish Karande, Lansing, MI (US); Kiran Misra, East Lansing, MI (US)

Correspondence Address: HARNESS, DICKEY & PIERCE, P.L.C., P.O. BOX 828, BLOOMFIELD HILLS, MI, 48303, US

(73) Assignee: Board of Trustees of Michigan State University, East Lansing, MI (US)

(21) Appl. No.: 11/906,989

(22) Filed: Oct. 4, 2007

Related U.S. Application Data
(60) Provisional application No. 60/849,329, filed on Oct. 4, 2006.

(51) Int. Cl. H04L 12/56; H04J 3/16

(52) U.S. Cl. 370/389; 370/465

(57) ABSTRACT

An improved routing scheme is provided for data packets in a network. Upon receiving incoming data packets at an intermediate routing node of the network, the incoming data packets are processed in accordance with a cross-layer protocol. In addition, network coding is applied to the incoming data packets to form a combined data packet which is in turn broadcast over the network.

### CROSS-REFERENCE TO RELATED APPLICATIONS

This application claims the benefit of U.S. Provisional Application No. 60/849,329, filed on Oct. 4, 2006. The disclosure of the above application is incorporated herein by reference.

### FIELD

The present disclosure relates to a framework for network coding and cross-layer information exchange in the presence of corrupt data packets.

### BACKGROUND

Network coding has found a wide variety of applications. Many research efforts have shown significant utility for combining network coding with the broadcast nature of wireless networks. Majority of the current studies, focus their analysis on packet networks, where the only possible channel impairments (if any) is a packet drop. Nevertheless some recent studies have shown that coding may provide performance gains on noisy channels, i.e., on channels that lead to symmetric errors.

The statements in this section merely provide background information related to the present disclosure and may not constitute prior art.

### SUMMARY

An improved routing scheme is provided for data packets in a network. Upon receiving incoming data packets at an intermediate routing node of the network, the incoming data packets are processed in accordance with a cross-layer protocol. In addition, network coding is applied to the incoming data packets to form a combined data packet which is in turn broadcast over the network.

Further areas of applicability will become apparent from the description provided herein. It should be understood that the description and specific examples are intended for purposes of illustration only and are not intended to limit the scope of the present disclosure.

### DRAWINGS

FIG. 1 is a diagram depicting a simplified communication topology for a portion of a wireless network;

FIG. 2 is a flowchart of an exemplary method for routing data packets in a wireless network;

FIG. 3 is a flowchart of an exemplary cross-layer protocol;

FIG. 4 is a graph illustrating the capacity results for four different routing schemes based on actual 802.11b error traces;

FIGS. 5A-5D are graphs illustrating the goodput as a function of coding rate for set 1, receiver A; set 1, receiver B; set 2, receiver A; and set 2, receiver B, respectively.

FIG. 6 is a diagram of the network topology described by Binary Symmetric Channels;

FIG. 7 is an exemplary chart which may be used to selecting an appropriate network coding function;

FIG. 8 is a flowchart of an exemplary routing scheme which employs network coding;

FIGS. 9A and 9B are graphs illustrating the parameter values for the optimal functions biased 0.5 and 0.25, respectively;

FIG. 10 is a chart illustrating an example of a compound binary symmetric channels; and

FIGS. 11A-11D are graphs illustrating the throughput gain of an adaptive network coding scheme in relation to non-adaptive schemes.

The drawings described herein are for illustration purposes only and are not intended to limit the scope of the present disclosure in any way.

### DETAILED DESCRIPTION

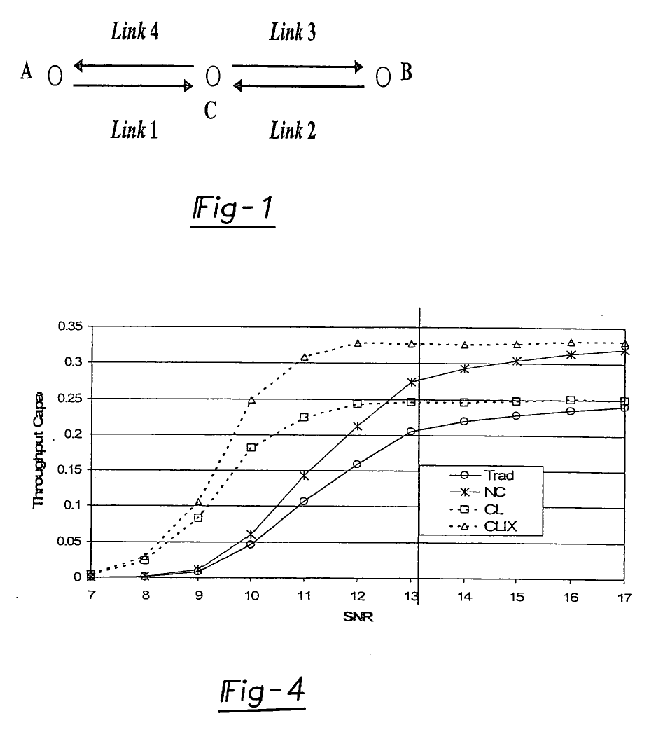

FIG. 1 depicts a network in which nodes A and B exchange mutually independent information. A single exchange consists of one or many transmissions from nodes A, B and C so as to facilitate the transmission of 1 packet each from node B to A and from node A to B. This disclosure focuses on exchanges that consist of a single transmission from node A and B. A network coding (NC) function is operated on these transmissions at node C. For purposes of this disclosure, two possible NC functions are: forwarding and coding. Forwarding uses two transmissions to forward the packets; that is, the packet received from A is related to B without any mixing. Coding uses an exclusive OR operation to combine packets into a single transmission that broadcasts the combined packet from C to A and/or B. Both A and B can recover the original packets by XOR-ing the received packet with the packet they transmitted. Other types of NC functions are contemplated by the broader aspects of this disclosure.

Consider a scenario where router C is placed such that the packet transmissions over links 1, 2, 3, and 4 are susceptible to bit corruptions. Such a scenario can occur in regions where a network is sparse and has to communicate over long distances or poor quality channels to remain connected. If a significant portion of packets on either of the links are dropped due to bit-corruptions, the exchange of information (despite the presence of network coding at an intermediate node) won't be efficient. Thus, in such a scenario, this disclosure proposes to employ a cross-layer protocol that allows the relay of corrupted packets and thus reduces the susceptibility to bit errors.

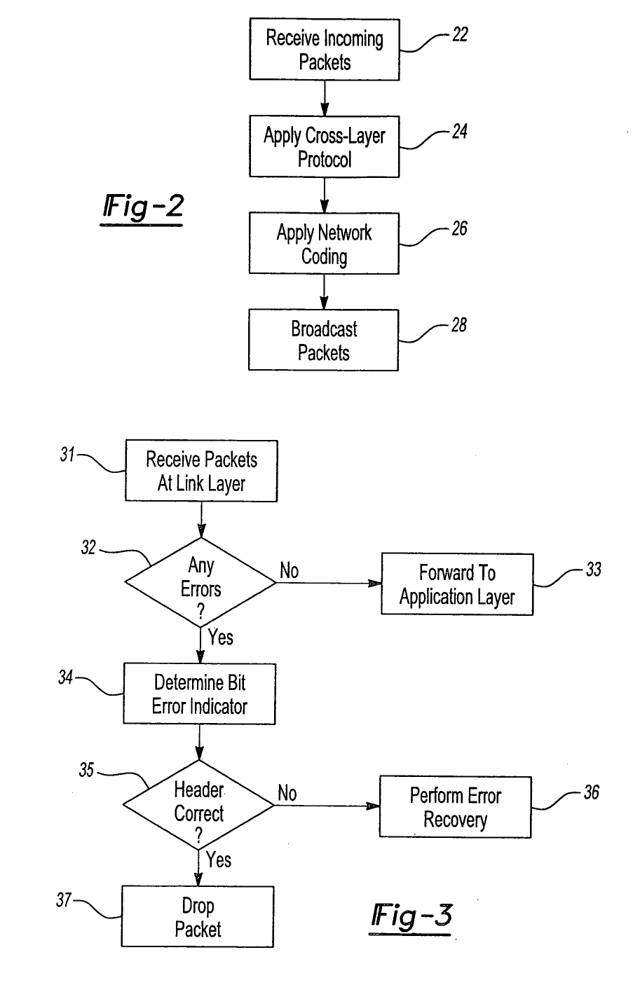

FIG. 2 illustrates an exemplary method for routing data packets using network coding and cross-layer information exchange in the presence of corrupt data packets. First, data packets received at an intermediate routing node, such as router C, are processed at 24 in accordance with a cross-layer protocol. In this disclosure, a cross-layer protocol generally refers to protocols (at link-level or above) that do not drop all data packets that contain residue errors (i.e., errors not corrected at the physical layer).

FIG. 3 illustrates an exemplary cross-layer protocol that was employed for this analysis. At a data link layer, incoming data packets are evaluated at 32 to determine whether they contain any errors. In an exemplary embodiment, the 802.11 MAC Frame Check Sequence (FCS) function can detect whether a received packet is error free. Other error checking mechanisms are contemplated by this disclosure. Data packets without any errors are sent on at 33 to the application layer of the receiver for further processing.

When a data packet is deemed to contain bit errors, the packet is further assessed to determine if the errors are found in the header of the data packet at 35, thereby obscuring the identity of the data packet. If a corrupted packet can be adequately identified from the header information, the packet is likewise forwarded on at 36 to the application layer for further processing. If the corrupted packet cannot be adequately identified, then the data packet is dropped at 37.

For each corrupted data packet sent to the application layer, an indicator of the bit errors associated with that data packet is also passed to the application layer. In an exemplary embodiment, the bit error indicator for the packet may be reported by the communication protocol operating at the data link layer of the receiver. For example, the bit error indicator may be a signal to silence ratio (SSR) value as provided in accordance with 802.11b WLAN. It is readily understood that other types of indicators for the bit errors contained in a given data packet are contemplated by this disclosure. Furthermore, it is contemplated that the bit error indicator may be captured at a physical layer of the receiver or at some other layer below the application layer as defined by the Open System Interconnection (OSI) model.

At the application layer, corrupt data packets undergo an error recovery operation at 36 which uses the bit error indicator associated with the corrupt data packet. In an exemplary embodiment, the bits of the corrupt data packet are decoded using a low density parity check decoding scheme. It is envisioned that bit error indictor may be used in other types of decoding schemes or forward error correction schemes. For details regarding how the bit error indicator is captured and then used to perform an error recovery operation may be found in U.S. patent application Ser. No. 11/725,242 filed on Mar. 16, 2007 and entitled “Method to Utilize Physical Layer Channel State Information to Improve Video Quality” which is incorporated herein by reference. While an exemplary cross-layer protocol has been described, it is readily understood that the broader aspects of this disclosure pertain to other types of cross-layer protocols.

Returning to FIG. 2, the cross-layer protocol is preferably applied prior to network coding. Network coding is then applied at 26 to the incoming data packets to form a combined data packet. In this exemplary embodiment, the NC function is an exclusive OR operation. Lastly, the combined data packet is broadcast 28 over the network. This exemplary method for routing data packets using network coding and cross-layer information exchange is referred to below as CLIX.

To evaluate the utility and feasibility of CLIX, a rigorous comparative evaluation is conducted for the four possible combinations that emerge from (i) employing traditional or cross-layer protocols on links 1, 2, 3, 4 and (ii) employing network coding (i.e. XOR-ing) or pure forwarding functionality at router C. Additional credence is lent to the evaluation by utilizing actual 802.11b wireless traces to emulate links 1, 2, 3 and 4. The analysis presented in this disclosure can be broken down into the following steps. First, based on some key parameters we deduce an abstract model to represent the communication over each link. The throughput capacity of each of the four schemes is deduced for such a model. Values of these key parameters, derived on the basis of actual 802.11b traces, are used to predict that CLIX should perform better than any other combination on an actual 802.11b wireless channel. Trace based simulations presented below validate this prediction. Second, we conduct forward error correction (FEC) analysis for multiple sets of actual 802.11b wireless traces. It is observed that for a variety of coding rates and realistic channel conditions, the goodput of CLIX is superior to that of other schemes. In addition, with the help of H.264 based video simulations, we exhibit the efficacy of CLIX in improving wireless video quality.

As XOR-ing of packets at an intermediate node or bit corruptions over the first hop alters the content of the packet, the header and the payload checksums have to be updated at the intermediate node. Additional meta-data also has to be inserted in the header at an intermediate node to allow the eventual receivers to identify the packets that were XORed at the intermediate node and to also identify, even when the transmission over the final hop is corruption free, packets which were corrupted on an initial hop. In this disclosure, we assume that the overhead due to this meta-data is negligible and due to brevity do not explicitly study the impact of such an assumption.

For ease of analysis, a slotted communication is assumed. In addition, it is assumed that the communication proceeds in terms of exchanges of individual packets. Each exchange involves the transmission of 1 packet each from A to B and B to A. In an exchange, packets are initially transmitted over link 1, 2 and then over links 3, 4. Thus a scheme employing network coding uses three transmission slots in each exchange, while a non-NC scheme uses 4 slots. If for some reason a packet involved in an exchange cannot be successfully transmitted within the slots allocated for the exchange, the packet is considered dropped. The above assumptions allow us to focus on issues core to the proposed work, without significantly compromising the validity of the analysis and conclusions.

In order to get an estimate of the performance gain from utilizing CLIX, we assume that the communication over links 1, 2, 3 and 4 is governed by an abstract channel. For communication over each of the links, we can consider a channel determined by 3 parameters, namely, (1) δ which denotes the probability that at least a single bit is in error in the header and/or in the data payload; (2) λ is the probability that the packet header contains at least a single bit in error; and (3) ε is the conditional probability of error in a packet conditioned on the event that a packet is corrupted and on the event that the header of the corrupted packet is error free. A traditional protocol drops a packet when either the header or payload has an error. Thus δ(λ) denotes the probability of a packet getting dropped when a link employs a traditional protocol. In contrast, a cross-layer protocol does not drop all packets which contain errors.

Returning to our assessment of CLIX, C_{A} (C_{B}) denotes the throughput capacity from B to A (A to B). The throughput capacity is determined by two factors, the number of slots that are required to exchange packets and also by the actual information rate in the received packets. The information rate can be reduced due to presence of bit errors or due to packet drops. Thus, it can be shown that the throughput capacity of traditional schemes and cross-layer schemes, which do not employ any network coding is given by equation (1) and (2):

$$\begin{matrix}{C}_{A\_trad} = ( 1 / 4 ) \cdot ( 1 - {δ}_{A} ) , {C}_{B\_trad} = ( 1 / 4 ) \cdot ( 1 - {δ}_{B} ) & ( 1 ) \\ \begin{matrix}{C}_{A\_CL} = ( 1 / 4 ) \cdot ( 1 - {δ}_{A} ) + ( {δ}_{A} - {λ}_{A} ) ( 1 - {h}_{b} ( {ɛ}_{A} ) ) \\ {C}_{B\_CL} = ( 1 / 4 ) \cdot ( 1 - {δ}_{B} ) + ( {δ}_{B} - {λ}_{B} ) ( 1 - {h}_{b} ( {ɛ}_{B} ) )\end{matrix} \} & ( 2 )\end{matrix}$$

where (i) δ_{A}=(1−δ₂)(1−δ₄), δ_{B}=(1−δ₁)(1−δ₃) denote the end-to end packet drop probability in traditional schemes; (ii) λ_{A}=((1−λ₂)(1−λ₄), λ_{B}=(1−λ₁)(1−λ₃) denotes the end-to-end packet drop probability in cross-layer schemes; and (iii) ε_{A}=(ε₂*ε₄), ε_{B}=(ε₁*ε₃) denotes the conditional probability of error in the corrupted un-erased packets received in cross-layer communication at receiver A and B, respectively.

When network coding is employed in conjunction with a traditional scheme, the packet drop process is identical to that of the traditional scheme; however the exchange occupies less number of slots. Thus throughput capacity for network coding is given by

C_{A}_{_{—}}_{NC}(⅓)·(1−δ_{A}), C_{B}_{_{—}}_{NC}=(⅓)·(1−δ_{B}) (3)

### Similarly, the throughput capacity of CLIX is given by

$$\begin{matrix}{C}_{A\_CLIX} = ( 1 / 3 ) \cdot ( \begin{matrix}( 1 - {δ}_{A\_CLIX} ) + \\ ( {δ}_{A\_CLIX} - {λ}_{A\_CLIX} ) ( 1 - {h}_{b} ( {ɛ}_{A\_CLIX} ) )\end{matrix} ) \\ {C}_{B\_CLIX} = ( 1 / 3 ) \cdot ( \begin{matrix}( 1 - {δ}_{B\_CLIX} ) + \\ ( {δ}_{B\_CLIX} - {λ}_{B\_CLIX} ) ( 1 - {h}_{b} ( {ɛ}_{B\_CLIX} ) )\end{matrix} )\end{matrix} \} \qquad ( 4 )$$

where, (i) 1−δ_{A}_{_{—}}_{CLIX} and 1−δ_{B}_{_{—}}_{CLIX} represent the probability of receiving a packet uncorrupted and un-erased at receiver A and B, respectively; (ii) (δ_{A}_{_{—}}_{CLIX}−λ_{A}_{_{—}}_{CLIX}) and (δ_{B}_{_{—}}_{CLLV}−λ_{B}_{_{—}}_{CLIX}) represent the probability that a packet is received un-erased but corrupted; and (iii) ε_{A}_{_{—}}_{CLIX} and δ_{B}_{_{—}}_{CLIX} represent the conditional probability of error in corrupted-unerased packets. Note that a CLIX packet is received error free (e.g., by receiver B), if and only if, the transmission on both hops (e.g., links 1 and 3 in FIG. 1) is corruption free and a packet is not XOR-ed with a corrupted packet (which happens either under error-free transmission over link 2 or a packet is dropped due to an error in the header over link 2, and hence no XOR-ing takes place). Thus we can deduce,

$$\begin{matrix}{δ}_{A\_CLIX} = 1 - ( 1 - {δ}_{2} ) ( 1 - {δ}_{4} ) ( 1 - {δ}_{1} + {λ}_{1} ) \\ {δ}_{B\_CLIX} = 1 - ( 1 - {δ}_{1} ) ( 1 - {δ}_{3} ) ( 1 - {δ}_{2} + {λ}_{2} )\end{matrix} \} \qquad ( 5 )$$

A packet is erased if and only if it encounters header corruption on either of the hops, thus λ_{A}_{_{—}}_{CLIX}=λ_{A}, λ_{B}_{_{—}}_{CLIX}=λ_{B}. There are seven possibilities that can lead to a packet being corrupted, but not being erased. Four of these possibilities include a corruption due to XOR-ing with a corrupted packet. The average probability of error over all such possibilities allows us to calculate ε_{A}_{_{—}}_{CLIX} and ε_{B}_{_{—}}_{CLIX}. Due to brevity, it is not feasible to step through each of these possibilities, but it can be easily shown that

$${ɛ}_{A\_CLIX} = ( 1 - {δ}_{1} + {λ}_{1} ) \cdot \{ \begin{matrix}( 1 - {δ}_{2} ) ( {δ}_{4} - {λ}_{4} ) {ɛ}_{4} + \\ ( 1 - {δ}_{4} ) ( {δ}_{2} - {λ}_{2} ) {ɛ}_{2} + \\ ( {δ}_{2} - {λ}_{2} ) ( {δ}_{4} - {λ}_{4} ) ( {ɛ}_{2} * {ɛ}_{4} )\end{matrix} \} + \\ ( {δ}_{1} - {λ}_{1} ) \cdot \{ \begin{matrix}( 1 - {δ}_{2} ) ( 1 - {δ}_{4} ) {ɛ}_{1} + \\ ( 1 - {δ}_{4} ) ( {δ}_{2} - {λ}_{2} ) ( {ɛ}_{1} * {ɛ}_{2} ) + \\ ( 1 - {δ}_{2} ) ( {δ}_{4} - {λ}_{4} ) ( {ɛ}_{1} * {ɛ}_{4} ) + \\ ( {δ}_{2} - {λ}_{2} ) ( {δ}_{4} - {λ}_{4} ) ( ( {ɛ}_{1} * {ɛ}_{2} ) * {ɛ}_{3} )\end{matrix} \} \qquad ( 6 )$$

### A similar expression can be deduced for ε_{B}_{_{—}}_{CLIX}.

There exist some combination of values for the above considered parameters, such that the performance of CLIX does not provide any advantage over network coding or cross-layer protocols and similarly there exist values for which CLIX can provide benefits. However, an important question to be raised is, “Which of these combinations are more likely to be observed on actual wireless channels?” For this purpose, we evaluate the values of δ, λ, ε, on the basis of actual 802.11b error traces. Traces are collected traces, with a total MAC-frame size of 1024 bytes which included a combined header size of 60 bytes. The traces were collected at a PHY data rate of 11 Mbps. The parameters δ, λ, ε were evaluated as a function of SNR.

For ease of analysis, links 1, 2, 3 and 4 are assumed to be governed by identical values of SNR and hence of identical δ, λ, ε. Thus, C=C_{A}=C_{B} and can be expressed as a function of SNR. FIG. 4 shows the result of such an evaluation. It can be seen that CLIX provides a better throughput capacity than any other scheme for all SNR values. A marker has been put on FIG. 4 to roughly demarcate (a) the SNR region where the cross-layer protocol aspect of CLIX allows it to perform better than network coding from (b) the SNR region where the network coding part of CLIX allows it to perform better than the cross-layer protocol.

The actual 802.11b channel exhibits temporal correlation in the error process, both at the packet level and at the bit-level. Though the values of δ, λ, ε were derived on the basis of actual traces, they may not capture the behavior of the 802.11b channel. It is important to simulate the behavior of the considered schemes on actual sample traces. For this purpose, two sets of error traces are considered. Each set consists of 4 traces, one to emulate each link. Each trace consists of 40,000 packets. The error traces in two sets, Set 1 and Set 2, are such that Set 1 represents a scenario where the communication over each link is highly susceptible to packet corruption, while Set 2 represents a scenario where packet corruptions are relatively rare. More specifically, the average SNR for each trace in Set 1 was lesser than 14 dB, while the SNR for each trace in Set 2 was in the range of 18-30 dB. As mentioned in the previous section, each MAC-frame in the error trace is of size 1024 bytes and consists of a combined header size of 60 bytes. A cross-layer scheme drops the packet whenever there is an error in the first 60 bytes of the frame, while a non-cross-layer scheme drops the packet whenever there is an error in any of the 1024 bytes in the frame.

For Set 1 and 2, the performance of Reed Solomon (RS) based FEC schemes employed in conjunction with network coding, cross-layer protocol and CLIX is considered. The FEC block-length was chosen in a manner to ensure that an FEC block gets exchanged in 240 transmission slots. Thus packet block-length for cross-layer was chosen to be 60, while the block-length for network coding and CLIX was chosen to be 80. Each FEC block consisted of 964 codewords interleaved over the packets, such that each packet contributed a symbol in GF(255) for each codeword.

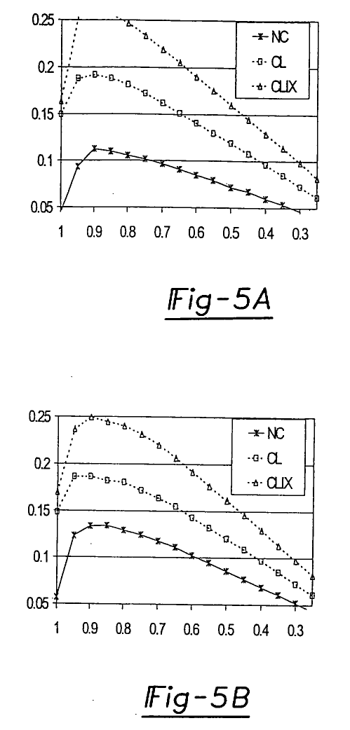

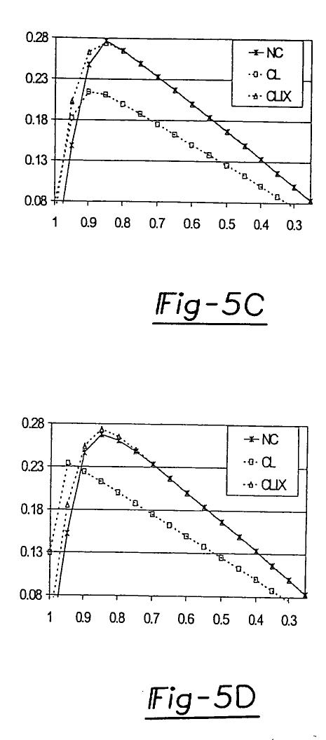

FIG. 5 shows the FEC performance for each scheme in terms of goodput: Γ=number of good packets received after FEC decoding per slot. Note that the bad (good) channel conditions associated with Set 1 (Set 2) are exhibited by the fact that the goodput of the cross-layer protocol (network coding) is better than network coding (cross-layer protocol). For both scenarios, the performance of CLIX is better than cross-layer protocol. The comparison of network coding and CLIX, shows that when packet corruptions are rare, CLIX and network coding perform identically; however, when the conditions deteriorate, the performance of CLIX is significantly better.

Next, whether the improvement in goodput can be translated into improvement in video quality is evaluated. The results are based on utilizing H.264 version 10.1 reference software. The picture frame size is maintained at 352×288 for all test sequences. All standard error concealment features have been turned on, a video packet size of 1024 bytes is used and specific source bit-rates are obtained using standard rate-control. The experiments in this section can be broken into two parts a) where the channel coding rate for the cross-layer protocol only, network coding only, and CLIX is identical and b) where the source coding rate is identical. As done in the previous section, the FEC block-length for the cross-layer protocol is maintained at 60 packets, while that for network coding and CLIX is maintained at 80 packets. First 8 rows of the table below provide the results for part (a) while the last 4 rows provide the results for part (b). Due to brevity, only a part of the results are presented, and only for receiver A.

For part (a), the channel coding rate is maintained at 0.7, thus the source bitrate used for network coding and CLIX is 4/3 times that used for cross-layer protocol. In the table, results associated with Set 1 exhibit that, when channel conditions are bad, the video quality offered by cross-layer protocols and CLIX can be significantly better than that of network coding. In addition, it can be incurred that CLIX can provide substantial improvement over cross-layer protocols too, especially in terms of motion continuity. Observations associated with Set 2 highlight the efficiency with which CLIX combines the advantages of network coding and cross-layer protocols.

In poor channel conditions the additional bandwidth available to network coding and CLIX is better used by providing additional redundancy. For part (b), the source bit-rate was maintained constant at 1.2 Mbps for all three schemes, while a channel coding rate of 0.525 was used for network coding and CLIX. The additional redundancy proves to be useful as shown in Table I below. Nevertheless, the performance of CLIX is still substantially better than network coding and cross-layer protocols individually.

### Video Quality in terms of PSNR, Offered by NC, CL, CLIX to Receiver A

| | | | Source | Coding | Frames | |
|---|---|---|---|---|---|---|
| Set | Scheme | Video | Bit Rate | Rate | Recovered | PSNR(db) |
| 1 | CL | foreman | 1.2 Mbps | 0.7 | 82% | 26.2 |
| 1 | NC | foreman | 1.6 Mbps | 0.7 | 12% | 13.1 |
| 1 | CLIX | foreman | 1.6 Mbps | 0.7 | 93% | 29.2 |
| 1 | CL | akiyo | 1.2 Mbps | 0.7 | 81% | 35.8 |
| 1 | NC | akiyo | 1.6 Mbps | 0.7 | 13% | 15.3 |
| 1 | CLIX | akiyo | 1.6 Mbps | 0.7 | 93% | 37.6 |
| 2 | CL | foreman | 1.2 Mbps | 0.7 | 100% | 41 |
| 2 | NC/CLIX | foreman | 1.6 Mbps | 0.7 | 100% | 42.1 |
| 1 | NC | foreman | 1.2 Mbps | 0.525 | 14% | 13.8 |
| 1 | CLIX | foreman | 1.2 Mbps | 0.525 | 97% | 30.1 |
| 1 | NC | akiyo | 1.2 Mbps | 0.525 | 18% | 17.8 |
| 1 | CLIX | akiyo | 1.2 Mbps | 0.525 | 98% | 40.6 |

Even for the actual 802.11b wireless channel, it is observed that advantages of network coding and cross-layer protocols can be efficiently combined. Theoretical and experimental deductions exhibited that CLIX provides an improvement in throughput capacity, FEC goodput and video quality.

Channel behavior observed in practical wireless networks exhibits a time-varying behavior. Under such a time-varying behavior the optimal network coding function employed at an intermediate node also varies with time. Consequently, an adaptive network coding (ANC) scheme, which alters the coding function in accordance to the Bit Error Rates (BER) in the packets, would naturally lead to a performance improvement. If each coding function utilizes an identical amount of network resource, an optimal ANC scheme could be easily designed by enumerating the performance of each coding function for the entire range of channel parameters and then choosing the best scheme for each channel condition. However when the network resources used vary with the coding function, the problem of designing an optimal ANC becomes harder and resembles a resource allocation problem. Thus, a framework is developed for design and analysis of an ANC suitable for efficient exchange of mutually independent information. We quantify the performance benefit offered by ANC on time-varying channel models derived from actual 802.11b and 802.15.4 wireless measurements. Our comparisons show significantly utility for employing an ANC when the variations in channel conditions are significant.

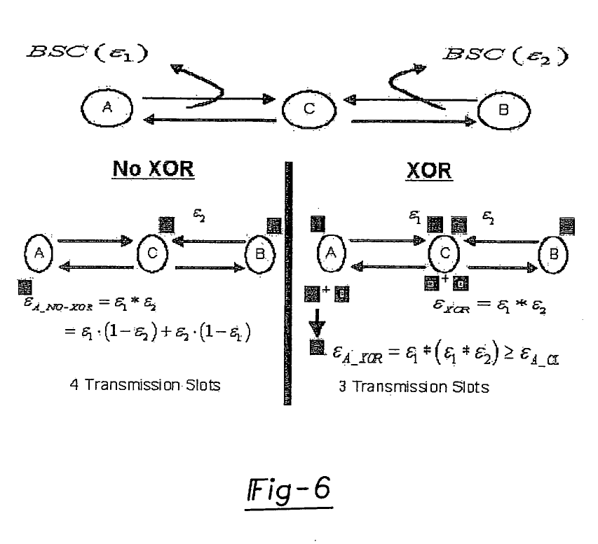

To motivate the discussion on noisy channels without processing, for now, let the channels be described by Binary Symmetric Channels (BSCs) as shown in FIG. 6. In the absence of complete processing, XOR-ing of corrupted packets can actually lead to error amplification as illustrated in FIG. 6. If the error-rates are sufficiently high, the capacity loss due to error amplification can offset the throughput gain on account of employing network coding. Additionally it should be noted that the error amplification is not identical for both A and B; implying that network coding functions may not be equally fair to the intended receivers.

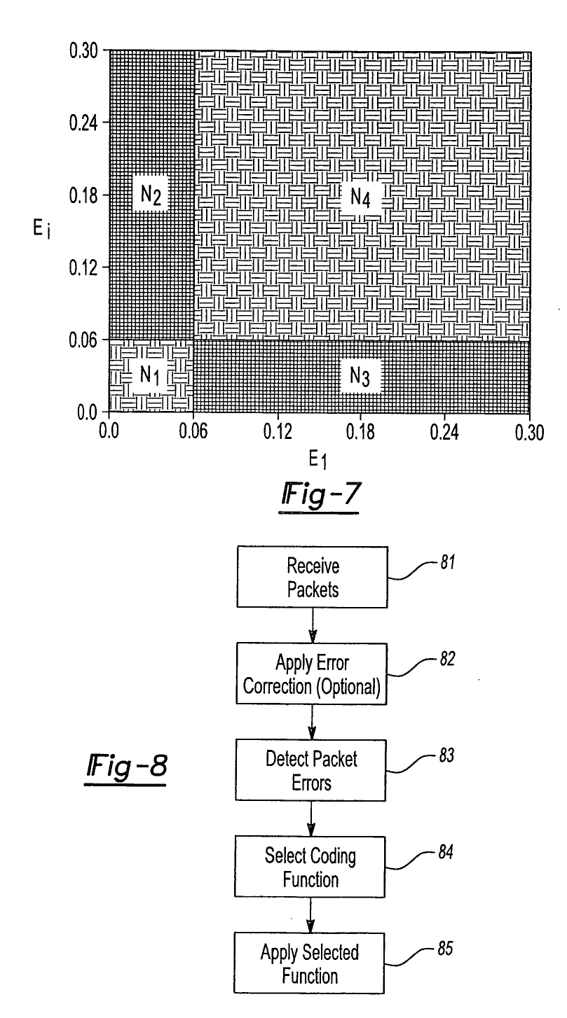

To illustrate this phenomenon, we obtain FIG. 7, by comparing the throughput capacity provided to each of the receiver under coding/forwarding. The expressions utilized to evaluate the throughput capacity are given by

C_{A}_{_{—}}_{NO-XOR}=C_{B}_{_{—}}_{No-XOR}+(¼)(1−h_{b}(ε₁*ε₂))

C_{A}_{_{—}}_{XOR}=(⅓)(1−h_{b}(ε₁*ε₁*ε₂))

C_{B}_{_{—}}_{XOR}=(⅓)(1−h_{b}(ε₁*ε₂*ε₂)) (7)

In this document, the operation “*” is defined such that p₁*p₂=p₁(1−p₂)+p₂·(1−p₁). The joint parameter space defined by BCS parameters (ε₁, ε₂) is partitioned into four regions depending upon the benefit of XOR-ing to each of the eventual receivers. XOR-ing improves throughput capacity to both receivers in region N₁. In region N₂, XOR-ing is beneficial only to B; whereas, in region N₃, XOR-ing is beneficial only to A. Forwarding the data packets separately is a better strategy for both A and B in region N₄. Thus, it can be observed that the coding is not always the best function and additionally under certain channel conditions neither of the functions are mutually beneficial.

FIG. 8 illustrates an exemplary routing scheme devised in accordance with this observation. A network coding function is applied to incoming data packets at an intermediate routing node based on the errors detected in the data packets. In an exemplary embodiment, a bit error indicator for each incoming data packet may be reported by the communication protocol operating at the data link layer of the receiver. For example, the bit error indicator may be a signal to silence ratio (SSR) value as provided in accordance with 802.11b WLAN. It is readily understood that other techniques for detecting and reporting the errors associated with a data packet are contemplated by this disclosure.

An appropriate network coding function is selected based on the error indicator. For example, the network coding function may be selected from one of combining the incoming data packets into an outgoing data packet for transmission over the network (i.e., XOR-ing) or forwarding the incoming data packets separately over the network. With reference to FIG. 7, when the errors detected in incoming data packets are less than a threshold (e.g., ε<0.06), then the exclusive OR operation is applied to the incoming data packets. When the error detected in incoming data packets are greater than a threshold, then the incoming data packets are forwarded separately over the network. When the errors detected in data packets from one source exceeds the threshold while errors in data packets from the other source are less than the threshold, a rule is applied which will favor one of the sources.

For time-varying channel conditions, a direct application of FIG. 7 may not be sufficient. This subtlety is illustrated with the help of the following example. Let the channel describing links 3 and 4 be error free. Let the channels describing links 1 and 2 be described by a compound BSC with two states. In one state, the channel behaves like a BSC (0.04) and in another the channel behaves like a BSC (0.3). Accordingly assume that, in an exchange, the channel state of line 1 and 2 are identical, with the joint states being represented by {BSC(0.04), BSC(0.04)} and {BSC(0.3), BSC(0.3)}. Let each of these joint states occur with the probability 0.5. We do not assume any transmitter side Channel State Information (CSI). However we assume that each node in the network including node C has receiver-side CSI. Hence node C can alter the NC function in accordance to the corruption levels in the received packets. For the above-described channel, the ANC policy obtained by a direct application of FIG. 7 dictates that 50% of the times the optimal NC function is FORWARDING, while for the remainder of the optimal function is CODING. Each time the received packets are corrupted by a BSC(0.3), node C relays the packets without XOR-ing. As against this the packets are XOR-ed and broadcast when they are corrupted by a BSC(0.04). The average throughput capacity under such a scheme is given by

$$\frac{Average Information Rate recd . per exchange}{Average No . of transmissions per exchange} = \frac{τ}{( 1 / R )} \\ = \frac{0.5 \cdot ( 1 - {h}_{b} ( 0.3 ) ) + 0.5 \cdot ( 1 - {h}_{b} ( 0.04 * 0.04 ) )}{0.5 \cdot 3 + 0.5 \cdot 4} = 0.1040$$

It can be easily verified that the best deterministic scheme is not represented by the above describe ANC. An ANC scheme that employs a coding function for the state {BSC(0.3), BSC(0.3)} and a forwarding function for the state {BSC(0.04), BSC(0.04)} performs better and provides a throughput capacity of 0.1109. The throughput capacity provided by only coding is 0.1046, while that provided by only forwarding is 0.1096.

From the above discussion, it is quite clear that ANC if designed appropriately can lead to performance benefits. However it is equally evident that a direct application of optimal rules at specific channel conditions may lead to the optimal ANC performance. An optimization problem that formally allows one to design an efficient ANC scheme is presented below. However prior to doing so, one more aspect of the considered problem requires to be highlighted.

For the considered topology, the performance of any NC scheme is given by the tuple {C_{A},C_{B}}. In this disclosure, we focus on scenarios where the overall performance can be represented as some scalarized version of the vector objective. Specifically, we concentrate on a performance objective that can be defined as a linear combination of the individual capacities provided to A and B:

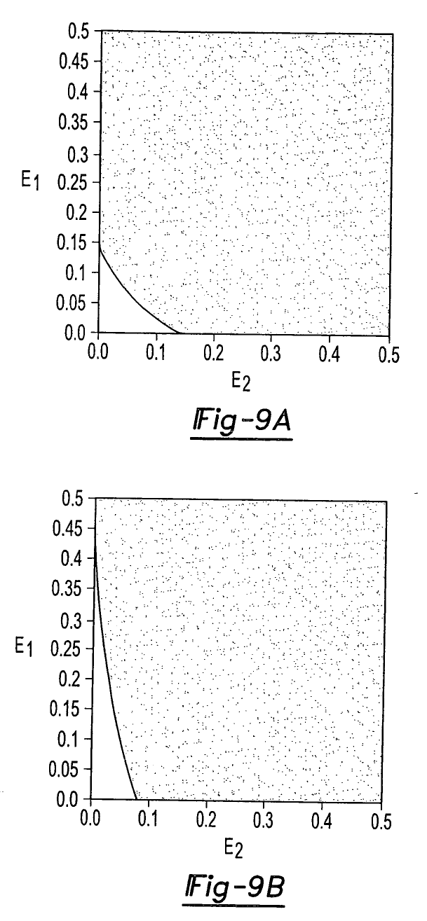

C=(w)C_{A}+(1−w)C_{B} (8)

where w can represent the bias or preference for a particular receiver. To illustrate the impact of w in determining the optimal function, we again assume that the links are governed by BSC as shown in FIG. 6. Utilizing equation (7) and (8) we determine the optimal functions for bias 0.5 and 0.25, as illustrated in FIGS. 9A and 9B, respectively. The un-shaded region represent the parameter values for which Coding is the optimal function while the shaded region represents the parameter values for which Forwarding is the optimal function. It can be clearly observed that even for static channels the optimal NC function is influenced by our bias towards a particular receiver. Similar effects are observed for compound channels that represent time-varying behavior.

Prior to stating the optimization problem that will facilitate the design of efficient ANC, certain preliminaries are developed in the following sub-sections. Assume that the time varying channel model can be described by a quasi-static compound BSC (CBSC). Assume that channel behavior remains static over the duration of transmission of single slot or packet, i.e. all the bits in a single packet are corrupted by an identical BSC. However the BSC parameter may vary across packets to form the compound BSC. Additionally the CBSC we consider can be described by a mass function \hat{f}(•) defined on some finite discrete subset S of the interval [0,0.5], such that, \hat{f}(p) represents the probability of the channel being described by a BSC with parameter p. For mathematical convenience we shall often utilize the continuous equivalent \hat{f}(•) given by

$$f ( p ) = \begin{matrix}0 & ∀ p ∉ S \\ \hat{f} ( p ) δ ( p ) & ∀ p ∈ S\end{matrix} \qquad ( 9 )$$

### Cascade of BSCs is a BSC, hence the cascade of CBSC is also a CBSC. Given two CBSB channels f₁ and f₂ the equivalent CBSC channel f_{eq} is given by

$${f}_{eq} ( p ) = {\sum }_{{{p}_{1} , {p}_{2} such that}_{p = {p}_{1} * {p}_{2}}} ( {f}_{1} ( {p}_{1} ) \cdot {f}_{2} ( {p}_{2} ) ) \qquad ( 10 )$$

The equivalent channel of a cascade of more than two channels is obtained by a repeated operation of the above equation. From here on we represent f_{eq} by f₁ [symbol] f₂ where [symbol] represents the operation described by (9). Additionally, since cascades of BSC are commutative, the cascades of CBSC are also commutative. Hence the equivalent channel obtained by cascade of more than two channels can just be represented as f₁ [symbol] f₂ [symbol] f₃ . . . . Additionally we shall often use a shortened notation f₁ [symbol] p₂ to represent the equivalent channel that is obtained by cascading f₁ with a BSC (p₂).

Assume a two-hop network topology as done in FIG. 6. However instead of assuming the channels to be BSC, we assume the channels to CBSC, such that, the channels from A to C, C to A, B to C, C to B are described the mass functions \hat{f}_{AC}, \hat{f}_{CA}, \hat{f}_{BC}, \hat{f}_{CB}, respectively. The domains, over which the functions \hat{f}_{AC}, \hat{f}_{CA}, \hat{f}_{BC}, \hat{f}_{CB} are defined, are given by S_{AC}, S_{CA}, S_{BC}, S_{CB} respectively. As done previously, we assume that the communication in the network takes place in terms of “exchanges”. Each exchange consists of packet transmission from A to C and B to C followed by packet transmissions from C. The number of packet transmissions from C are dependent upon the “exchange rules” being employed at C and the corruption levels in the packets received by C. Thus we assume that receiver-side CSI is available at all the nodes.

Let Λ be set of coding functions that can be employed at a relay node. An exchange rule describes the probability with which a coding function is employed, given the corruption levels in the packets received at the relay node. For the model considered here the coding functions operate only on two packets. Thus for each coding function we define a “rule” as a function

λ_{c}_{ᵢ}:[0,0.5]×[0,0.5]→[0,1] (11)

such that λ_{c}_{ᵢ}(p₁,p₂) represents the probability of coding function cᵢ being employed when a packet received from A is corrupted by BSC(p₁), while that received from B is corrupted by BSC(p₂). The rules so defined thus satisfy the following restriction.

$${\sum }_{{c}_{i} ∈ Λ} {λ}_{{c}_{i}} ( {p}_{1} , {p}_{2} ) = 1 ∀ {p}_{1} , {p}_{2} ∈ [ 0 , 0.5 ] \qquad ( 12 )$$

As stated previously, in this work we restrict our attention to the functions {cᵢ≡CODING,c₂≡FORWARDING}. Since we employ only two possible functions, from here on λ_{c}_{₁}(p₁,p₂) is simply represented by λ(p₁,p₂) while λ_{c}_{₂}(p₁,p₂) is represented by λ̅(p₁,p₂)=1−λ(p₁,p₂).

Two important special cases of exchanges rules are given by

λ(p₁,p₂)=1∀p₁,p₂ε[0,0.5] (13)

λ(p₁,p₂)=0∀p₁,p₂ε[0,0.5] (14)

where (13) represents a scheme that always employs CODING, while (14) represents a scheme that always employs FORWARDING.

The throughput capacity provided to each receiver is determined by the corruption in the received packets and also by the rate at which the packets are received. The distribution of BERs in the packets received by a node can be mapped to an equivalent reception CBSC, f_{eq}. For such a channel, the Ergodic capacity is given by

$$τ = {\int }_{0}^{0.5} {f}_{eq} ( p ) ( 1 - {h}_{b} ( p ) ) d p \qquad ( 15 )$$

The equivalent channel will be dependent on the employed exchange rule λ. We shall describe how we can obtain the equivalent channel shortly, but for now let's assume that we have some mechanism to do so. As explained above the throughput capacity will also be determined by the rate at which packets are received. We can measure the rate by evaluating the average number of slots used in each exchange and then taking the reciprocal. Thus the rate, R is given by

$$R = 1 / ( {\int }_{0}^{0.5} {\int }_{0}^{0.5} ( \begin{matrix}3 \cdot {f}_{AC} ( {p}_{1} ) {f}_{BC} ( {p}_{2} ) λ ( {p}_{1} , {p}_{2} ) + \\ 4 \cdot {f}_{A C} ( {p}_{1} ) {f}_{BC} ( {p}_{2} ) \overline{λ} ( {p}_{1} , {p}_{2} )\end{matrix} ) d {p}_{1} d {p}_{2} ) \qquad ( 16 )$$

Hence the average throughput capacity is given by:

C=τ·R (17)

### The eventual performance measure we are interested in will be determined by a linear combination of the throughput capacity provided to each receiver, as described by equation (8).

The equivalent channels required to determine the capacity can be easily determined when the exchange rule is always:

FORWARDING: f_{A}_{_{—}}_{eq}=f_{BC} [symbol] f_{CA}, f_{B}_{_{—}}_{eq}=f_{AC} [symbol] f_{CB}

CODING: f_{A}_{_{—}}_{eq}=f_{BC} [symbol] f_{CA} [symbol] f_{AC}, f_{B}_{_{—}}_{eq}=f_{AC} [symbol] f_{CB} [symbol] f_{BC}

### The rates for the above rules are determined by the function itself (0.25 for CODING and ⅓ for FORWARDING) and hence the throughput capacity can be easily determined.

In the following we illustrate the determination of the equivalent reception CBSC for an arbitrary exchange rule. To do so, first consider the scenario when f_{AC} and f_{BC} are represented by BSC (p_{AC}) and BSC (p_{BC}). For such a channel conditions the equivalent reception channels are given by:

f_{A}_{_{—}}_{eq}(p₁,p₂)=λ(p₁,p₂)(f_{CA} [symbol] (p_{AC}*p_{BC}))+ λ̅(p₁,p₂)(f_{CA} [symbol] p_{BC})

f_{B}_{_{—}}_{eq}(p₁,p₂)=λ(p₁,p₂)(f_{CB} [symbol] (p_{AC}*p_{BC}))+ λ̅(p₁,p₂)(f_{CB} [symbol] p_{AC}) (18)

### The above scenario can now be generalized to the case where f_{AC} and f_{BC} are arbitrary CBSC as

$${f}_{A\_eq} = {\sum }_{{p}_{1} ∈ {S}_{A C - {p}_{2}} ∈ {S}_{A C}} ( {\hat{f}}_{A C} ( {p}_{1} ) \cdot {\hat{f}}_{BC} ( {p}_{2} ) ( {f}_{A\_eq} ( {p}_{1} , {p}_{2} ) ) ) \\ {f}_{B\_eq} = {\sum }_{{p}_{1} {eS}_{A C * {p}_{2}} {eS}_{A C}} ( {\hat{f}}_{A C} ( {p}_{1} ) \cdot {\hat{f}}_{BC} ( {p}_{2} ) ( {f}_{B\_eq} ( {p}_{1} , {p}_{2} ) ) ) \qquad ( 19 )$$

The design of an efficient ANC scheme requires the design of an optimal exchange rule λ((p₁,p₂). The optimal exchange rule in general is a non-parametric function described on the two-dimension space [0,0.5]×[0,0.5]. Thus to make the problem tractable we shall quantize the parameter space [0,0.5]×[0,0.5] into m suitable rectangular intervals. Such interval can be represented as

Iᵢ≡[p₁ᵢ−Δ₁ᵢ, p₁ᵢ+Δ₁ᵢ]×[p₂ᵢ−Δ₁ᵢ, p₂ᵢ+Δ₂ᵢ]∀iε[1,m]

### For such a quantization we define the mass function

$${\tilde{f}}_{i} = {\int }_{{I}_{1}} {f}_{A C} ( {p}_{1} ) {f}_{BC} ( {p}_{1} ) d {p}_{1} d {p}_{2}$$

which represents the probability of receiving a pair of packets corrupted by BSCs with parameter values in the interval Iᵢ. Additionally we restrict our attention to exchange rules that remain constant over each interval. Thus an exchange rule can now be represented by identifying a λᵢ for each Interval. The equivalent reception channels can thus be approximated as

$$\begin{matrix}{\tilde{f}}_{A\_eq} = {\sum }_{i = 1}^{m} {λ}_{i} ( {\tilde{f}}_{i} \cdot ( {f}_{CA} ⊗ ( {p}_{1 i} * {p}_{2 i} ) ) ) + \\ {\sum }_{i = 1}^{m} \overline{{λ}_{i}} ( {\tilde{f}}_{i} \cdot ( {f}_{CA} ⊗ {p}_{2 i} ) )\end{matrix} \\ \begin{matrix}{\tilde{f}}_{B\_eq} = {\sum }_{i = 1}^{m} {λ}_{i} ( {\tilde{f}}_{i} \cdot ( {f}_{CB} ⊗ ( {p}_{1 i} * {p}_{2 i} ) ) ) + \\ {\sum }_{i = 1}^{m} \overline{{λ}_{i}} ( {\tilde{f}}_{i} \cdot ( {f}_{CB} ⊗ {p}_{1 i} ) )\end{matrix} \qquad ( 20 )$$

### Let

aᵢ=\tilde{f}ᵢ·(E_{f}_{_{CA}} [symbol] ₍ₚ_{₁ᵢ}_{*p}_{₁ᵢ}₎[1−h_{b}(p)]), āᵢ=\tilde{f}ᵢ·(E_{(f}_{_{CA}} [symbol] ₚ_{₂ᵢ}₎[1−h_{b}(p)])

bᵢ=\tilde{f}ᵢ·(E_{f}_{_{CB}} [symbol] ₍ₚ_{₁ᵢ}_{*p}_{₁ᵢ}₎[1−h_{b}(p)]), b̅ᵢ=\tilde{f}ᵢ·(E_{(f}_{_{CB}} [symbol] ₚ_{₂ᵢ}₎[1−h_{b}(p)])

### The Ergodic Capacity for the equivalent reception channels is thus suitably approximated by

$${τ}_{A} = {\sum }_{i = 1}^{m} {a}_{i} {λ}_{i} + {\sum }_{i = 1}^{m} \overline{{a}_{i}} \overline{{λ}_{i}} , {τ}_{B} = {\sum }_{i = 1}^{m} {b}_{i} {λ}_{i} + {\sum }_{i = 1}^{m} \overline{{b}_{i}} \overline{{λ}_{i}} \qquad ( 21 )$$

### Now, also observe that the rate given in equation (16) can also be approximated as

$$R = 1 / {\sum }_{i = 1}^{m} {λ}_{i} ( {\overline{f}}_{i} \cdot 3 ) + {\sum }_{i = 1}^{m} \overline{{λ}_{i}} ( {\overline{f}}_{i} \cdot 4 ) \qquad ( 22 )$$

Thus from equations (21) and (22) we can state the problem of designing optimal exchange rules as the following optimization problem:

### Linear-Fractional Program (LFP):

$$maximize F = \frac{{\sum }_{i = 1}^{m} {α}_{i} {λ}_{i} + {\sum }_{i = 1}^{m} \overline{{α}_{i}} \overline{{λ}_{i}}}{{\sum }_{i = 1}^{m} {β}_{i} {λ}_{i} + {\sum }_{i = 1}^{m} {β}_{i} \overline{{λ}_{i}}} ( in variables {λ}_{i} , \overline{{λ}_{i}} ) \qquad ( 23 )$$

### Subject to

λ₁+ λ̅₁=1; 0≦λ₁, λ̅₁≦1 for i:=1, . . . , m

where

α₁=(w)αᵢ+(1−w)bᵢ, α̅₁=(w) α̅ᵢ+(1−w) b̅ᵢ, β₁=\vec{f}ᵢ·3, β̅₁=\vec{f}ᵢ·4

are channel dependent constants.

With slight mathematical jugulary it may be feasible to convert the above program into a Linear Program. However this leads to an increase in the total number of variables in the optimization algorithm. Hence we use a slightly different approach, which in practice provides us with a sufficiently fast convergence. We illustrate our approach in terms of the following two-optimization algorithms.

### Linear-Program (LP):

$$F ( R ) = {max}_{{λ}_{i} , \overline{{λ}_{i}}} {\sum }_{i = 1}^{m} ( R {α}_{i} ) {λ}_{i} + {\sum }_{i = 1}^{m} ( R \overline{{α}_{i}} ) \overline{{λ}_{i}} \qquad ( 24 )$$

### Subject to

$${λ}_{i} + \overline{{λ}_{i}} = 1 ; 0 \leq {λ}_{i} , \overline{{λ}_{i}} \leq 1 for i := 1 , … , m$$

$${\sum }_{i = 1}^{m} {β}_{i} {λ}_{i} + {\sum }_{i = 1}^{m} {β}_{i} \overline{{λ}_{i}} = R$$

### Single-Variable Convex-Problem:

$$F = {max}_{R} F ( R ) subject to 0.25 \leq R \leq ( 1 \text{/} 3 ) \qquad ( 25 )$$

We obtain the solution for problem (23), by solving (25) as a single variable optimization problem on a constrained domain. In our approach, the gradient direction at the boundaries is evaluated to first verify that the optimum is not at a boundary. Following this we adopt the following iterative algorithm:

Initialize: R_{left}=0.25, R_{right}0.3

Interative R₁=(F(R_{left})R_{left})R_{left}+F(R_{right})R_{right})

Update: If R_{left}<R_{right}R_{right}:=R₁ ELSE R_{left}:=R_{new}

Stopping Criteria: Stop if |R_{left}−R_{right}|<Δ_{threshold}

Note that the enumeration of the above algorithm requires us to solve an instance of problem (25) in each iteration. Also note that the quantized exchange rule obtained in accordance to the above approach can be applied over the entire parameter space with the help of suitable interpolation.

The time-varying channel models we use to illustrate the utility of the proposed approach are derived from actual 802.11b and 802.15.4 wireless measurements. It is observed that practical radio devices are capable of associating a Signal-to-Silence Ratio (SSR) with each received packet. Empirical measurements thus allow the evaluation of the following relationships:
δ(SSR) which represents the probability of receiving a corrupted packet with a particular SSR indication.
ε(SSR) which represents the average BER in corrupted packets with a particular SSR indication.

### We derive our channel models by equating Signal to Noise Ratio (SNR) with SSR, assuming some distribution g(SNR) on the variation of SNR. The time-varying channel is given by

$$\hat{f} ( 0 ) = {\sum }_{S S R} g ( S S R ) ( 1 - δ ( S S R ) ) , \hat{f} ( ɛ ( S S R ) ) = δ ( S S R ) g ( S S R ) .$$

In practice, it is observed that the SSR/SNR variations can often be approximated by a Gaussian distribution. Thus in this work we concentrate on channel models obtained by assuming a Gaussian distribution for g(SNR). FIG. 10 provides an example of a CBSC obtained in such a manner.

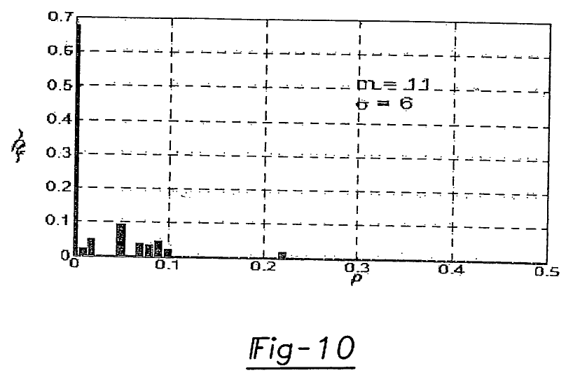

We compare the performance of ANC with only FORWARDING and only CODING in terms of the ratio of the throughput capacities provided by each of the schemes. We focus on w=0.5 and hence comparison in terms of throughput capacity are sufficient to describe the performance of both the receivers. Thus, FIG. 6 plots the ratio of the throughput capacity under ANC and CODING with that under FORWARDING. As should have been expected, the performance of CODING can be worse than FORWARDING in the low SNR region of the 802.11b plots. However, in all the plots in FIG. 11 it can be observed that the performance of ANC is always better than both the non-adaptive schemes. On 802.15.4 channels ANC provides a modest improvement of 1-2% over CODING and 5-20% gains over FORWARDING. On 802.11b, ANC provide a significant improvement over both non-adaptive schemes. A minimum gain of 5% is consistently seen on the entire range of studied channel conditions. ANC provides a gain of 5-15% over FORWARDING and 5-60% on CODING. It can be observed that the performance gains of ANC increase with variation in the channel conditions. For SNR values higher than a certain threshold, the performance of ANC and CODING is almost identical. Thus the performance benefits of ANC are expected to be more pronounced in challenged wireless networks.

The above description is merely exemplary in nature and is not intended to limit the present disclosure, application, or uses.

What is claimed is:

1. A routing scheme for data packets in a network, comprising:
receiving two or more incoming data packets at an intermediate routing node of the network;
processing the incoming data packets in accordance with a cross-layer protocol;
applying network coding to the incoming data packets to form a combined data packet; and
broadcasting the combined data packet over the network.

2. The routing scheme of claim 1 wherein processing the incoming data packets further comprises selectively forwarding incoming data packets having bit errors therein.

3. The routing scheme of claim 1 wherein processing the incoming data packets further comprises passing information regarding errors in the data packets between layers of the Open Systems Interconnection (OSI) model.

4. The routing scheme of claim 1 further comprises processing incoming data packets in accordance with a cross-layer protocol prior to applying network coding.

5. The routing scheme of claim 1 wherein processing the incoming data packets further comprises detecting errors in at least one of the incoming data packets at a given layer of the Open Systems Interconnection (OSI) model; and applying an error correction operation to the incoming data packets at a different layer of the OSI model.

6. The routing scheme of claim 1 wherein applying network coding further comprises applying an exclusive OR operation to the incoming data packets.

7. The routing scheme of claim 1 further comprises adapting network coding to account for conditions of the links traversed by the data packets.

8. The routing scheme of claim 7 wherein adapting network coding further comprises dropping select data packets to achieve a net gain in throughput.

9. A method for routing data packets in a network, comprising:
receiving two or more incoming data packets at an intermediate routing node of the network;
detecting errors in at least one of the incoming data packets at a given layer of the Open Systems Interconnection (OSI) model;
applying an error correction operation to the incoming data packets at a different layer of the OSI model based on information passed from the given layer, prior to combining the incoming data packets; and
combining the incoming data packets into an outgoing data packet for transmission over the network.

10. The method of claim 9 further comprises broadcasting the outgoing data packet across the network

11. The method of claim 9 further comprises
capturing an indicator of bit errors for each of the data packets at a data link layer;
passing the bit error indicator for each of the data packets to an application layer; and
performing an error recovery operation in relation to a given data packet at the application layer using the bit error indicator associated with the given data packet

12. The method of claim 11 wherein the bit error indicator is further defined as a signal to silence ratio for each data packet as reported in accordance with the 802.11b standard.

13. The method of claim 11 wherein performing an error recovery operation further comprises decoding bits of the given data packet using a low density parity check decoding scheme.

14. The method of claim 11 wherein the error recovery operation is further defined as a forward error correction scheme.

15. The method of claim 9 wherein combining the incoming data packets further comprises applying an exclusive OR operation to the incoming data packets.

16. A routing scheme for data packets in a network, comprising:
receiving two or more incoming data packets at an intermediate routing node of the network;
detecting errors in each of the incoming data packets;
selecting a network coding function in accordance with the detected errors in the incoming data packets; and
applying the selected network coding function to the incoming data packets.

17. The routing scheme of claim 16 wherein the network coding function is selected from one of combining the incoming data packets into an outgoing data packet for transmission over the network or forwarding the incoming data packets separately over the network.

18. The routing scheme of claim 16 further comprises capturing an indicator of bit errors for each of the data packets at a data link layer.

19. The method of claim 18 wherein the bit error indicator is further defined as a signal to silence ratio for each data packet as reported in accordance with the 802.11b standard.

20. The routing scheme of claim 16 further comprises applying an exclusive OR operation to the incoming data packets when the errors detected in each incoming data packet is less than a threshold.

21. The routing scheme of claim 16 further comprises forwarding each of the incoming data packets separately over the network when the errors detected in each incoming data packet is greater than a threshold.

22. The routing scheme of claim 16 further comprises applying an error correction operation to the incoming data packets prior to selecting a network coding function.

23. A method for constructing an adaptive network coding scheme for a wireless communication network, comprising:
defining an exchange rule for each networking coding function to be employed at a given network node, where each exchange rule describes a probability with which a corresponding network coding function is employed;
defining a throughput capacity to the given network node in terms of errors found in incoming data packets and rate at which the incoming data packets are received;
approximating the errors found in incoming data packets as a function of the exchange rules; and
optimizing the throughput capacity for the given network node to thereby determine the exchange rules.

24. The method of claim 23 wherein the network coding functions include combining the incoming data packets into an outgoing data packet for transmission over the network and forwarding the incoming data packets separately over the network.
